(19) United States
(12) Patent Application Publication
(10) Pub. No.: US 2006/0270469 A1
(43) Pub. Date: Nov. 30, 2006

(54) Wireless communication device and method of operation thereof

(76) Inventors: Jon Godston, Chicago, IL (US); Michael E. Caine, Needham, MA (US); Karsten Aagaard, Loudon, TN (US); Tadeo T. Toulis, Boston, MA (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/137,192

(22) Filed: May 25, 2005

(51) Int. Cl. H04M 1/00

(52) U.S. Cl. 455/575.3; 455/575.1

(57) ABSTRACT

A wireless communication device (100) and method of operation thereof are provided. The wireless communication device includes a first housing portion (102) and a second housing portion (106). The second housing portion (106) is rotatably coupled to the first housing portion (102). The wireless communication device (100) is adapted to provide a simultaneous translational and rotational motion between the second housing portion (106) and the first housing portion (102).

### FIELD OF THE INVENTION

The present invention relates generally to the field of communication systems. In particular, the present invention relates to operating a wireless communication device.

### BACKGROUND OF THE INVENTION

Wireless communication devices are widely used for voice and data communication, remote monitoring, position finding, and other purposes. Examples of wireless communication devices include cellular telephones, mobile telephones, messaging devices, Personal Digital Assistants (PDAs), and portable computers. Technological advancements have provided an increased portability of such devices through overall size reductions.

Wireless communication devices can communicate using radio frequency (RF) channels, such as the Global System of Mobile (GSM) communication system in an 850 Mega Hertz (MHz) or a 900 MHz frequency band, on the Digital Communication System (DCS) at an 1800 MHz frequency band, or a Personal Communication System (PCS) at a 1900 MHz frequency band. Wireless communication devices further can operate on other wireless channels such as the Global Positioning Systems (GPS) that operates at 1.575 Giga Hertz (GHz), Bluetooth operation at 2.4 GHz, and Universal Mobile Telecommunications Service (UMTS) that uses the spectrum from 1.92 GHz to 1.98 GHz for transmission and 2.11 GHz to 2.17 GHz for reception.

Conventionally, wireless communication devices are available in different designs such as “candy bar-type”, “flip-type” and “folder-type”. The candy bar-type wireless communication device typically includes, a main housing, a keypad serving as data input means, a display serving as data output means, transmitting modules and receiving modules contained within the main housing.

The flip-type wireless communication device typically includes a main housing, a flip, and a hinge unit to connect the flip to the main housing. Data input and output devices, and modules that transmit and receive data are contained within the main housing. The flip may be horizontally pushed/slided over the main housing and released for it to rotate under the action of a spring mechanism.

The folder-type wireless communication device includes a main housing, a folder, and a hinge unit. The hinge unit connects the folder to the main housing, thus enabling the rotation of the folder. The folder-type wireless communication device may be opened and closed by the rotation of the folder. When the folder-type wireless communication device is in the standby mode, the folder covers the main housing. When the folder-type wireless communication device is in the communication mode, the folder is released from the main housing.

One of the problems with today's wireless communication devices is that there is a considerable distance between the transmitting and receiving units, which limits the miniaturization of the wireless communication device.

Moreover, in operation, the length of the wireless communication device increases when the flip or the folder is released from the main housing. This may lead to an inferior RF performance and may also reduce the aesthetics of the design of the wireless communication device.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an example of a wireless communication device, in which various embodiments of the present invention are practiced.

FIG. 2 illustrates an example of a first side view of a hinge assembly in a wireless communication device, in accordance with an embodiment of the present invention.

FIG. 3 illustrates an example of a second side view of a hinge assembly in a wireless communication device, in accordance with an embodiment of the present invention.

FIG. 4 illustrates an example of a first view of a detent in a wireless communication device, in accordance with an embodiment of the present invention.

FIG. 5 illustrates an example of a first top view of a detent in a wireless communication device, in accordance with an embodiment of the present invention.

FIG. 6 illustrates an example of a second top view of a detent in a wireless communication device, in accordance with an embodiment of the present invention.

FIG. 7 illustrates an example of a third top view of a detent in a wireless communication device, in accordance with an embodiment of the present invention.

FIG. 8 illustrates an example of a first view of a detent in a wireless communication device, in accordance with an alternate embodiment of the present invention.

FIG. 9 illustrates an example of a second view of a detent in a wireless communication device, in accordance with an alternate embodiment of the present invention.

FIG. 10 illustrates an example of a third view of a detent in a wireless communication device, in accordance with an alternate embodiment of the present invention.

FIG. 11 illustrates an example of a top view of a first portion of a hinge assembly, in accordance with an embodiment of the present invention.

FIG. 12 illustrates an example of a top view of an interconnect cable routing through a second portion of a hinge assembly, in accordance with various embodiments of the present invention.

FIG. 13 is a flowchart illustrating a method of operating a wireless communication device, in accordance with various embodiments of the present invention.

Skilled artisans will appreciate that the elements in the figures are illustrated for simplicity and clarity, and have not necessarily been drawn to scale. For example, the dimensions of some of the elements in the figures may be exaggerated in relation to other elements to improve the understanding of the embodiments of the present invention.

### DETAILED DESCRIPTION

In an embodiment, a wireless communication device includes a first housing portion and a second housing portion. The second housing portion is rotatably coupled to the first housing portion. Further, the second housing portion is adapted for a simultaneous translational and rotational motion in relation to the first housing portion.

In another embodiment, a method of operation of a wireless communication device, having a first housing portion and a second housing portion, is provided. The first housing portion is rotatably coupled to the second housing portion. The second housing portion executes a simultaneous translational and rotational motion with respect to the first housing portion.

Before describing in detail, a wireless communication device and method of operation thereof, in accordance with the present invention, it should be observed that the present invention resides primarily in combinations of method steps and apparatus components related to the operation of wireless communication device. Accordingly, the apparatus components and method steps have been represented, where appropriate, by conventional symbols in the drawings. These drawings show only the specific details that are pertinent for understanding the present invention, so as not to obscure the disclosure with details that will be apparent to those with ordinary skill in the art and the benefit of the description herein.

In this document, relational terms such as first and second, top and bottom, and the like may be used solely to distinguish one entity or action from another entity or action, without necessarily requiring or implying any actual such relationship or order, between such entities or actions. The terms ‘comprises’, ‘comprising’, or any other variation thereof, are intended to cover a non-exclusive inclusion, such that a process, method, article, or apparatus that comprises a list of elements, does not include only those elements, but may include other elements not expressly listed or inherent to such process, method, article, or apparatus. An element preceded by ‘comprises . . . a’ does not, without more constraints, preclude the existence of additional identical elements in the process, method, article, or apparatus that comprises the element.

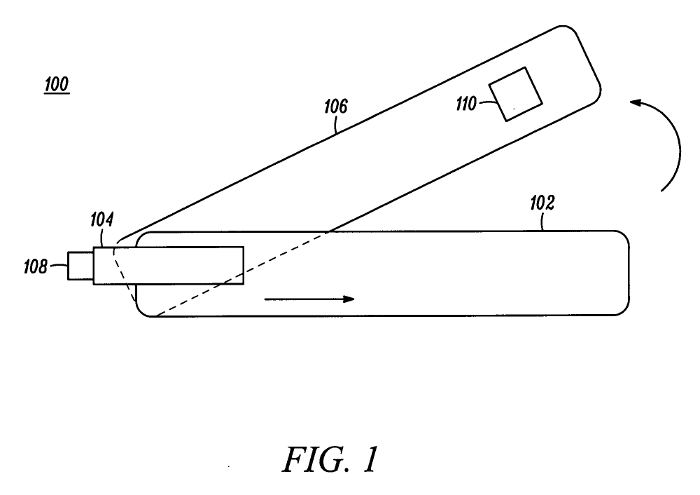

FIG. 1 illustrates a wireless communication device 100, in which various embodiments of the present invention are practiced. The wireless communication device 100 includes a first housing portion 102, a hinge assembly 104, and a second housing portion 106. The first housing portion 102 further includes a first antenna element 108, and the second housing portion 106 further includes a second antenna element 110. The second housing portion 106 is rotatably coupled to the first housing portion 102, using the hinge assembly 104. The second housing portion 106 is also adapted for simultaneous translational and rotational motion with respect to the first housing portion 102. Further, the axis of the hinge assembly 104 is linearly translated when the second housing portion 106 is rotated with respect to the first housing portion 102. In an embodiment of the present invention, the first antenna element 108 and the hinge assembly 104 are linearly positioned in the wireless communication device 100.

In various embodiments of the invention, the first antenna element 108 and the second antenna element 110 may be a dipole antenna, a notch antenna, a tri-band antenna, a hoop antenna, a 3rd-Generation (3G) antenna, or an equivalent. In an embodiment of the invention, the first antenna element 108 is a hoop antenna.

It will be appreciated by those of ordinary skill in the art that the wireless communication device 100 may be a mobile telephone, a cellular telephone, a cordless telephone, a wireless personal digital assistant, a wireless personal computer, or an equivalent.

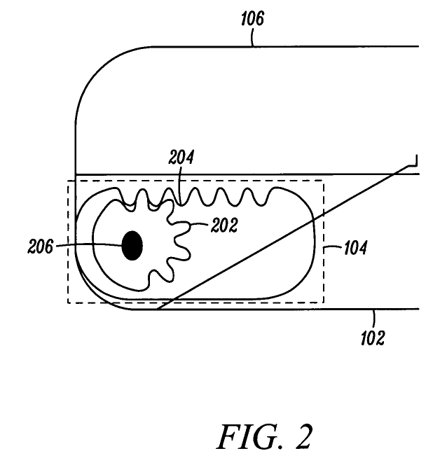

FIG. 2 illustrates an example of a first side view of the hinge assembly 104 in the wireless communication device 100, in accordance with an embodiment of the present invention. The hinge assembly 104 includes a pinion 202, a rack 204, and an interconnect cable 206. The pinion 202 further includes teeth. The rack 204 includes a channel to trap the teeth of the pinion 202. The rack 204 and the pinion 202 translate the axis of the hinge assembly 104 linearly when the second housing portion 106 is rotated with respect to the first housing portion 102. The interconnect cable 206 enables signal coupling between the first housing portion 102 and the second housing portion 106. In particular, the interconnect cable 206 enables signal coupling between the first antenna element 108, and the second antenna element 110. Further, the interconnect cable 206 transcends through a central opening along the axis of the pinion 202.

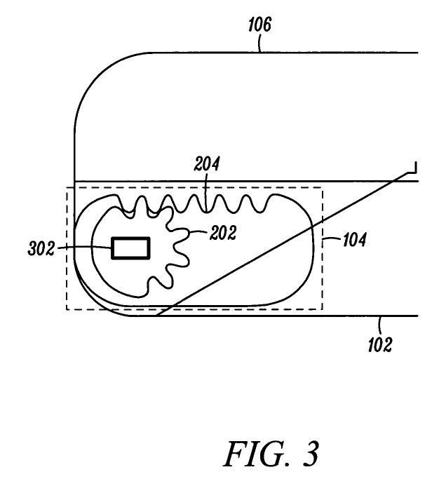

FIG. 3 illustrates an example of a second side view of the hinge assembly 104 in the wireless communication device 100, in accordance with an embodiment of the present invention. The hinge assembly 104 further includes a detent 302. The detent 302 provides position stability to the second housing portion 106. In various embodiments of the invention, the detent 302 provides position stability to the second housing portion 106 by holding the second housing portion 104 in a predefined position such as a closed position, a mid-open position and an open position, with respect to the first housing portion 102.

In alternate embodiments of the present invention, the hinge assembly 104 may include more than one pinion, more than one rack and/or a plurality of detents within the wireless communication device 100.

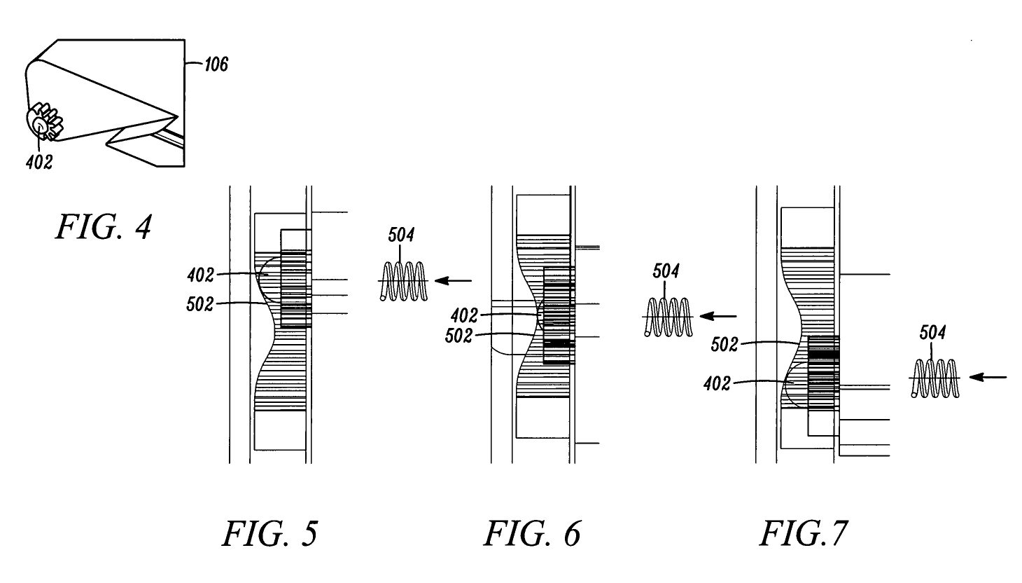

FIG. 4 illustrates an example of a first view of the detent 302 in the wireless communication device 100, in accordance with an embodiment of the present invention. The detent 302 includes a spring-loaded sliding plunger 402, which is fixed in relation to the second housing portion 106.

FIG. 5 illustrates an example of a first top view of the detent 302 in the wireless communication device 100, in accordance with an embodiment of the present invention. A cam profile 502 is located within a first channel of the first housing portion 102. The first channel of the first housing portion 102 is positioned opposite the second channel, which contains the interconnect cable 206. Further, the spring-loaded sliding plunger 402 presses against the cam profile 502, which causes the second housing portion 104 to rotate to a predefined position of stability. In various embodiments of the invention, the spring-loaded sliding plunger 402 includes a spring 504 that maintains the spring-loaded sliding plunger 402 in the relaxed and stressed state. In FIG. 5, the spring loaded sliding plunger 402 is in an initial pre-loaded state, relatively-lightly pressing against the cam profile 502 of the first housing portion 102. This position is the closed position of the second housing portion 106, with respect to the first housing portion 102.

FIG. 6 illustrates an example of a second top view of the detent 302 in the wireless communication device 100, in accordance with an embodiment of the present invention. In the transition from FIG. 5 to FIG. 6, the spring-loaded sliding plunger 402 is compressed by the cam profile 502 as the second housing portion 106 is forcibly rotated to the mid-open position, with respect to the first housing portion 102.

FIG. 7 illustrates an example of a third top view of the detent 302 in the wireless communication device 100, in accordance with an embodiment of the present invention. In the transition from FIG. 6 to FIG. 7, the spring-loaded sliding plunger 402 presses against the cam profile 502 to rotate the second housing portion 106 to the open position, with respect to the first housing portion 102.

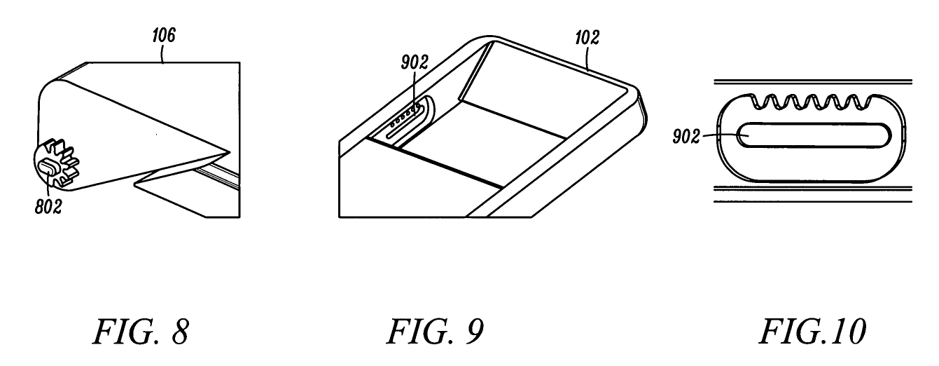

In an alternate embodiment of the present invention, the detent 302 includes the cam profile 502 in a cam spring mechanism. This mechanism is described in conjunction with FIG. 8, FIG. 9, and FIG. 10.

FIG. 8 illustrates an example of a first view of the detent 302 in the wireless communication device 100, in accordance with an alternate embodiment of the present invention. The detent 302 provides position stability to the second housing portion 106 using a cam-spring mechanism. As-illustrated in FIG. 8, the cam-spring mechanism includes a flat-keyed end 802.

FIG. 9 illustrates an example of a second view of the detent 302 in the wireless communication device 100, in accordance with an alternate embodiment of the present invention. FIG. 9, shows a slot 902 in the first housing portion 102. The flat-keyed end 802 rests in a slot 902 in the first housing portion 102. The flat keyed-end 802 slides along the slot 902 in the first housing portion 102, during the transverse motion of the hinge assembly 104 and the second housing portion 106, in relation to the first housing portion 102. Further, while sliding the slot 902, the flat-keyed end 802 exerts a torque on the opposing walls of the slot 902. This torque causes the second housing portion 106 to rotate to the pre-defined open or closed position of stability.

FIG. 10 illustrates an example of a third view of the detent 302 in the wireless communication device 100, in accordance with an alternate embodiment of the present invention. FIG. 10 illustrates the slot 902 in the first housing portion 102. In an embodiment of the invention, the cam-spring mechanism is fixed in relation to the second housing portion 106.

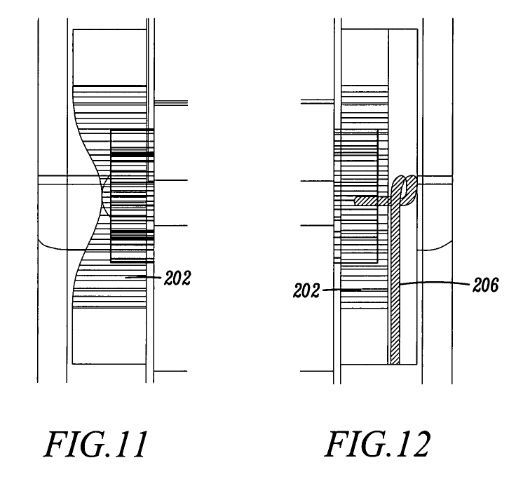

FIG. 11 illustrates an example of a top view of a first portion of the hinge assembly 104, in accordance with an embodiment of the present invention.

FIG. 12 illustrates an example of a top view of the interconnect cable 206 routing through a second portion of the hinge assembly 104, in accordance with various embodiments of the present invention. The interconnect cable 206 transcends through an opening along the central axis of the pinion 202. The interconnect cable 206 provides signal coupling between the first housing portion 102 and the second housing portion 106. In particular, the interconnect cable 206 can provide signal coupling between the first antenna element 108 and the second antenna element 110.

In various embodiments of the invention, the interconnect cable 206 may be a flex cable, a co-axial cable, or an optical cable.

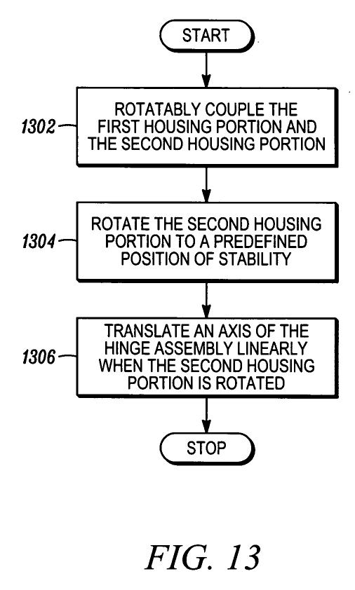

FIG. 13 is a flow chart illustrating a method for operating the wireless communication device 100, in accordance with various embodiments of the present invention. At step 1302, the first housing portion 102 is rotatably coupled to the second housing portion 106. In an embodiment of the invention, the hinge assembly 104 is used for rotatably coupling the first housing portion 102 and the second housing portion 106. At step 1304, the second housing portion 106 is rotated to a pre-defined position of stability. In various embodiments of the invention, the pre-defined positions of stability include a closed position, a mid-open position, and an open position. Further, the detent 302 is used to automatically rotate the second housing portion 106 to the pre-defined open or closed position of stability. At step 1306, an axis of the hinge assembly 104 is translated linearly when the second housing portion 106 is rotated. This is done by trapping the teeth of the pinion 202 in the channel of the rack 204.

The present invention, as described herein, provides a simultaneous translational and rotational motion within the wireless communication device 100. According to various embodiments of the present invention, an axis of the hinge assembly 104 is translated linearly, when the second housing portion 106 is rotated with respect to the first housing portion 102. This is achieved by using the rack 204 and the pinion 202 construction of the hinge assembly 104.

Implementation of the present invention reduces the overall length of the wireless communication device 100 in the open position of the second housing portion 106 with respect to the first housing portion 102. According to various embodiments of the present invention, a part of the second housing portion 106 is inserted into the rack 204 in the first housing portion 102 (in an open position), which reduces the overall length of the wireless communication device 100 in the open position.

The present invention provides superior RF performance to the wireless communication device 100. This is due to the fact that when the second housing portion 106 is opened with respect to the first housing portion 102, the second housing portion 106 is closer to the first antenna element 108, thus improving the RF performance in the wireless communication device 100.

Further, the linear positioning of the hinge assembly 106 and the first antenna element 108 enhance the aesthetics of the design of the wireless communication device 100. This is because, when the second housing portion 106 is closed over the first housing portion 102, linear positioning of the hinge assembly 106 and the first antenna element 108 allows the first antenna element 108 to have a hoop-shaped form. Furthermore, when the second housing portion 106 is opened with respect to the first housing portion 102, the gap between the second housing portion 106 and the first housing portion 102 is reduced. This results in enhanced aesthetics of the wireless communication device 100.

In the foregoing specification, the invention, its benefits and advantages have been described with reference to specific embodiments. However, one of with ordinary skill in the art appreciates that various modifications and changes can be made without departing from the scope of the present invention as set forth in the claims below. Accordingly, the specification and figures are to be regarded in an illustrative, rather than a restrictive sense, and all such modifications are intended to be included within the scope of the present invention. The benefits, advantages, solutions to problems, and any element(s), that may cause any benefit, advantage, or solution to occur or become more pronounced, are not to be construed as critical, required, or essential features or elements of any or all the claims. The invention is defined solely by the appended claims, including any amendments made during the pendency of this application, and all equivalents of those claims as issued.

We claim:

1. A wireless communication device comprising:
a first housing portion; and
a second housing portion rotatably coupled to the first housing portion, wherein the second housing portion is adapted for simultaneous translational and rotational motion with the first housing portion.

2. The wireless communication device of claim 1, further comprising a hinge assembly for rotatably coupling the first housing portion and the second housing portion, wherein the hinge assembly provides the simultaneous translational and rotational motion.

3. The wireless communication device of claim 2, wherein the hinge assembly comprises:
at least one pinion, each of the at least one pinion comprising teeth;
at least one rack, each of the at least one rack comprising a channel to trap the teeth of each of the at least one pinion, wherein the at least one rack and the at least one pinion translate the axis of the hinge assembly linearly when the second housing portion is rotated; and
a plurality of detents, the plurality of detents providing position stability to the second housing portion.

4. The wireless communication device of claim 3, wherein each of the plurality of detents comprises:
a cam profile, the cam profile located within a first channel of the first housing portion opposite to a second channel of the first housing portion comprising an interconnect cable, the interconnect cable enabling signal coupling between the first housing portion and the second housing portion; and
a spring-loaded sliding plunger fixed relative to the second housing portion, wherein the spring-loaded sliding plunger end presses against the cam profile, causing the second housing portion to rotate to the predefined open or closed position of stability.

5. The wireless communication device of claim 4, wherein each of the plurality of detents further comprises the cam profile in a cam-spring mechanism which includes a flat keyed-end, wherein a main body of the cam-spring mechanism is fixed relative to the second housing portion, while the flat keyed-end rests in a slot in the first housing portion to slide along the slot during transverse motion of the hinge assembly and of the second housing portion relative to the first housing portion.

6. The wireless communication device of claim 4, wherein the flat keyed-end exerts a torque on the opposing walls of the slot during transverse motion of the hinge assembly relative to the first housing portion, causing the second housing portion to rotate to the predefined open or closed position of stability.

7. The wireless communication device of claim 2, wherein the hinge assembly further comprises an interconnect cable, the interconnect cable enabling signal coupling between the first housing portion and the second housing portion.

8. The wireless communication device of claim 7, wherein the interconnect cable transcends through an opening along the central axis of the at least one pinion.

9. The wireless communication device of claim 1, further comprising an antenna located within the first housing portion.

10. The wireless communication device of claim 9, wherein the antenna is a hoop antenna.

11. The wireless communication device of claim 9, wherein the antenna and the hinge assembly are linearly positioned.

12. The wireless communication device of claim 9, wherein the antenna comprises:
a first antenna element located within the first housing portion; and
a second antenna element located within the second housing portion, wherein the interconnect cable enables signal coupling between the first antenna element and the second antenna element.

13. The wireless communication device of claim 1, wherein the wireless communication device is selected from the group consisting of a mobile telephone, a cellular telephone, a cordless telephone, a wireless personal digital assistant, and a wireless personal computer.

14. A method of operation of a wireless communication device having a first housing portion and a second housing portion, the method comprising:
rotatably coupling the first housing portion to the second housing portion; and
providing simultaneous translational and rotational motion between the second housing portion and the first housing portion.

15. The method of operation of claim 14 further comprising:
mechanically coupling a hinge spring having a flat keyed end to a slot in the first housing portion, wherein opposing walls of the slot comprise a plurality of detents; and
exerting a torque by the hinge spring on the opposing walls of the slot to cause transverse motion of the second housing portion with respect to the first housing portion.

16. A method of operation within a wireless communication device comprising:
rotatably coupling a first housing portion and a second housing portion using a hinge assembly;
rotating the second housing portion to a predefined position of stability using a spring-loaded sliding plunger, which is fixed relative to the second housing portion; and
translating an axis of the hinge assembly linearly when the second housing is rotated by trapping one or more teeth of at least one pinion within at least one rack within the second housing portion.
